(19) United States
(12) Patent Application Publication
(10) Pub. No.: US 2011/0093386 A1
(43) Pub. Date: Apr. 21, 2011

(54) TRANSACTION SYSTEM AND METHOD

(75) Inventors: Gareth Phillips, Midlothian (GB); Alan Shropshire, Pebbleshire (GB)

(73) Assignee: The Royal Bank of Scotland, Intellectual Property Unit, Group Secretariat

(21) Appl. No.: 12/989,031

(22) PCT Filed: Apr. 28, 2009
(86) PCT No.: PCT/EP09/55148

§ 371 Date: Dec. 13, 2010

(30) Foreign Application Priority Data
Apr. 28, 2008 (GB) 0807676.2

(51) Int. Cl. G06Q 40/00

(52) U.S. Cl. 705/39

(57) ABSTRACT

Described is an automated transaction processing system and method, including at least one bank account record and associations between the record and at least a first account identifier and a second account identifier for the account, the system and method comprising a transaction processor, to process received transaction requests identifying the account on the basis of first criteria, if the transaction request identifies the account using the first identifier, or second, different criteria, if the transaction request identifies the account using the second identifier. The system and method can provide increased security in financial transactions by employing different criteria according to whether or not transactions are permitted, based on the form of the account identifier.

### FIELD OF THE INVENTION

The present invention relates to financial transaction systems and methods and particularly, but not exclusively, to systems and methods in which financial accounts can be identified by more than one account identifier.

### BACKGROUND OF THE INVENTION

Systems for enacting financial transactions are widespread and well known. Such systems within a bank are commonly referred to as transaction processing systems, although financial institutions other than banks (for example, building societies, credit card issuers, co-operatives, e-money institutions, credit unions etc.) operate and use such systems and infrastructures. Accordingly, the terms ‘bank’ and ‘banking’ are used herein is a non-limiting way to encompass all kinds of institutions which use and/or operate such systems and infrastructures.

Bank accounts are generally opened by legal entities (“account holders”), such as individuals, companies or other organisations. Typically, accounts are used to hold funds and can receive credits or satisfy debits as long as sufficient funds (or credit facilities) are available. There are many kinds of bank account, for example cash accounts, checking accounts, credit card accounts, deposit accounts, current accounts, offset accounts, mortgage accounts etc., and the present invention is in no way limited to any particular kind of account. In general, all such accounts are identified by an identifier, which may be a number or an alphanumeric string, which will be referred to herein as an ‘account identifier’. Account identifiers typically comply with a standard banking format. For example, in the UK, domestic bank accounts are typically designated by a standard BACS 14-digit number comprising a six digit bank account sort code and an eight digit bank account number. Sort codes were designed to identify the bank branch that holds the account—and each bank may have allocated to it one or more sort code ranges—whereas the bank account number identifies the actual bank account. For a BACS account number, the first pair of digits of the sort code typically designates the bank whereas the later numbers may designate a particular subsidiary or branch of the bank. Other countries have similar account identifiers, though aspects and embodiments of the present invention are in no way limited to BACS accounts identifiers.

Banking systems and infrastructures frequently handle inter-account funds transfers or payments, which can be credits or debits depending on which way the funds are flowing in relation to originating and destination accounts. Such transfers or payments will be referred to generally herein as ‘transactions’. Transactions typically identify both the bank and account to which funds are directed or from which funds should be paid. When the transaction arrives at the destination bank, the bank manages the transaction by reference to the account identifier. In general, a banking transaction that attempts to identify a bank account with an incorrect or non-standard identifier will fail.

Individual banks typically operate their own proprietary transaction processing system, which services bank accounts and provides inter-account transfers for accounts that it holds. Each bank may have different proprietary processes, data formats and systems for servicing their account and transactions between their accounts; or they may apply known standards instead.

However, for transactions between banks (i.e. inter-bank transactions), the banks are obliged to use appropriate data format standards to ensure transactions can complete successfully. Payment transactions between UK banks, for example, can use BACS, CHAPS, or Faster Payments utilising APACS formats and infrastructures. Payments between banks in Europe can use SEPA arrangements, payments between banks in the US can use Fedwire and payments between banks in Japan can use BOJ-NET. Payments between banks internationally can use SWIFT among other services. There are many other well-known options. In common, however, is the need to ensure a transaction conforms to the respective standard of the system being used and that it accurately identifies a destination bank account using the correct account identifier.

Aspects and embodiments of the present invention apply to all kinds of bank account systems, including (but not limited to) UK domestic, European, US and Japanese.

In general, as already stated, banking transactions must identify a destination bank account into which funds should be transferred or from which funds should be debited. Knowledge of the destination bank account identifier is typically essential in order to carry out a banking transaction with the account. However, knowledge of the bank account identifier is also a perceived security risk. For example, it is known to be possible to carry out a fraudulent banking transaction using knowledge of a bank account identifier; for example, it has been possible to set up a fraudulent automated direct debit, which withdraws small amounts of money from an account each month without being noticed by the account holder. Therefore, it is desirable to limit the number of people who have knowledge of bank account identifiers, in order to limit the risk of a fraudulent transaction taking place.

It would be desirable to provide financial transaction systems and methods having increased security, that facilitate banking transactions using standard identifiers but with reduced risk of fraud.

### SUMMARY OF THE INVENTION

In accordance with a first aspect, the present invention provides an automated transaction processing system, including at least one bank account record and associations between the record and at least a first account identifier and a second account identifier for the respective account, the system comprising a transaction processor, to process received transaction requests identifying the account on the basis of first criteria, if the transaction request identifies the account using the first identifier, or second, different criteria, if the transaction request identifies the account using the second identifier.

In accordance with a second aspect, the present invention provides a method of enacting a financial transaction including by: issuing at least two account identifiers for an account; and processing transaction requests identifying the account on the basis of first criteria, if the transaction request identifies the account using the first identifier, or second, different criteria, if the transaction request identifies the account using the second identifier.

In accordance with a third aspect, the present invention provides a banking system including a first financial transaction system and a second financial transaction system, in communication with one another via a communication infrastructure system, at least the first or the second financial transaction system comprising an automated transaction processing system as descried herein.

According to aspects and embodiments of the present invention, and unless the context dictates otherwise, “system” as used herein may encompass an individual bank's system and infrastructure, or a broader banking (e.g. inter-banking) infrastructure.

Advantageously, the system and method can provide increased security in financial transactions by adapting a transaction processing system to employ different criteria to whether or not transactions are permitted, based on the form of the account identifier received in a transaction request. This provides account holders with increased control when communicating account identifiers to third parties, and provides unscrupulous third parties and fraudsters with less opportunity to extract funds from an account holder's account without the permission of the account holder.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagram illustrating an end-to-end banking system including an originating transaction processing system and a destination transaction processing system;

FIG. 2 is a diagram showing in more detail the destination transaction processing system of FIG. 1;

FIG. 3 is a flow diagram showing the steps involved in a banking transaction according to an exemplary embodiment of the present invention; and

FIG. 4 is a diagram of an exemplary computer interface according to an embodiment of the present invention.

### DETAILED DESCRIPTION OF THE INVENTION

According to a first exemplary embodiment of the present invention, a normal bank account having a standard account identifier is augmented by the provision of a second identifier. Using the UK domestic system by way of example only, the account identifier is a 14-digit BACS code, comprising a six digit sort code and an eight digit account number, for example 12345612345678 (where 123456 is the sort code and 12345678 is the account number). In addition, the second identifier is also a 14-digit BACS code, for example 1230788199999.

The sort code of the first identifier is 123456 whereas the sort code of the second identifier is 123078. In this example, it is assumed that the bank that holds the account is identified by the first two digits, 12, and has been allocated the sort code range 123000-123999. Accordingly, any third party bank or system will know to direct a transaction containing either account identifier to the same bank. In other words, both identifiers comply with the BACS standard and will be treated the same within existing banking infrastructures and systems. The significance of the numbers that follow the sort code is, at least initially, known only to the bank that holds the account and the account holder.

According to the present embodiment, the first identifier is traditionally used in all debit and credit transactions associated with the account. The second identifier is a so-called ‘synthetic’ account identifier according to the present embodiment. As will become clear, a synthetic account identifier may be provided to accompany any existing or new bank account. The association between the actual and synthetic account identifiers is known only by the bank account holder and the bank holding and servicing the account. In this way, the bank account holder has a choice of whether to provide the first or second bank account identifier to a third party. The significance of this will now be explained in more detail.

A bank servicing a bank account that has associated with it both first and second identifiers can implement a more secure transaction processing system that is adapted to apply different rules or criteria to the processing of transactions originating from third parties. Hitherto, typically, different criteria can only be applied to different accounts. In a simple example, the transaction processing system is adapted to permit both credits and debits to be applied to a bank account (subject to normal authorization steps) if a respective transaction destined for the account uses the first, actual account identifier. However, the transaction processing system is also adapted to apply restricted criteria, for example whereby only credits are permitted, if a respective transaction request is received that uses the second, synthetic account identifier. In this way, the account holder can with greater confidence distribute the synthetic account identifier widely to enable deposits into his account, with the knowledge that any attempt to use the synthetic account identifier to apply a debit to the account would fail, since the respective bank account is being serviced by a transaction processing system that is adapted to apply enhanced security provisions. The actual account identifier may then only be known to, and reserved for use by, the account holder: such that only the account holder or trusted third parties can request a debit on the account.

A particular benefit of a transaction processing system according to embodiments of the invention is that it may be adapted to recognise and process a second, synthetic account identifier that shares in common with the first, actual identifier a standard format that can be used by any other bank, transaction processing system or banking infrastructure without any changes thereto being required. A change that needs to take place, however, is the need for a transaction processing system according to embodiments of the invention to recognise two or more identifiers and to be able to associate the synthetic account identifier with the actual account identifier or directly with the account.

Beyond the clear advantages described above, the second, synthetic account identifier can be arranged to be personalized so that it can be easily remembered by the account holder and readily distributed to others. In one particularly advantageous example of personalization, the account identifier comprises a telephone number or partial telephone number of the account holder and may include international prefixes. In the example provided above, the final eleven of the fourteen digits of the second identifier are, in fact, an exemplary UK mobile telephone number, 07881 999 9999. Currently, mobile telephone numbers in the UK all start with a 07. The leading numbers of the overall identifier, that is “123078” (where the zero, seven and eight are common to both the sort code and the telephone number), fall within the range allocated to the bank holding the account. In essence, the bank has flexibility, within the ranges of sort codes it has available to it, to facilitate use of an account holder's telephone number or partial telephone number to act as a second identifier.

Accordingly, an account holder can inform third parties to make a payment into an his account by specifying three (or possibly more depending on the sort code range available) leading digits and a telephone number, which may be a mobile telephone number or a fixed-line (land line) telephone number and may or may not include a country prefix. Of course, many people (e.g. friends, colleagues, employers etc.) will already have the telephone number, and so they may only need to be informed of the leading digits in order to be able to make a payment into the respective bank account. In any event, no third party needs to know the actual bank account identifier in order to make a payment into the account. Thus, the opportunity for fraud is greatly reduced.

As already described, in cases where a payer knows a telephone number, he may also need to know additional leading digits in order to complete a 14 digit BACS code. In other embodiments, it is anticipated that it will be sufficient to know the destination bank (for example RBS™, NATWEST™, CITIZENS™), and the banking system and/or transaction processing system or infrastructure would be adapted to contain a mapping from a bank name to the leading three (or more) digits, in order to generate the second identifier according to the required standard. Indeed, it is also within the scope of embodiments of the invention to apply a standard that permits a bank to be identified using the bank name (or other known designator) and an additional account reference, which may be a personal telephone number. It is already known, for example, in the UK and Europe, to identify a bank using its Bank Identifier Code (BIC), and such known designations could be used in a standard for account identifiers according to embodiments of the present invention. In other words, an identifier, which identifies a bank by name or other designator, may not need to be converted into the leading three (or any other number of) digits: a bank name and telephone number would suffice to satisfy an end to end transaction.

While a telephone number can be used to generate a second, synthetic bank account number, any other kind of number or designator would find practical application according to embodiments of the present invention. For example, the number might comprise a birth date or a full or partial national insurance or social security number (or any combinations thereof). Indeed, the number may be randomly or arbitrarily selected within the limitations of the account identifiers available to the bank. However, use of a telephone number has clear benefits of being unique, well known to the account holder and already known to others. In addition, a birth date or national insurance number, while well known to the account holder, are personal details that may be used in identify fraud, whereas a telephone number is typically not as sensitive.

Use of a telephone number according to the present embodiment has additional benefits and advantages. For example, a transaction processing system may be adapted to communicate with the account holder using the telephone number.

It is already known for banks to communicate account balances etc. to their account holders. However, this kind of service typically requires the account holder to register for the service with their own bank, including by providing their telephone number, and only their own bank can communicate in this way.

In an exemplary scenario according to embodiments of the present invention, an originating bank of a third party payer may also communicate transaction details to a recipient, even if the recipient does not have an account with the originating bank. The recipient does not even have to register or sign up for any kind of service. The transaction details may be communicated to the recipient, for example, by automated SMS, text message, interactive voice response/automatic voice recognition (IVR/AVR), or the like, as soon as the transaction has been initiated, by using a telephone number in the account identifier. Thus, the recipient account holder knows as soon as a transaction has been initiated. Currently, it is typically only possible to know a transaction has taken place when cleared funds have arrived in the account holder's bank account. In addition, or alternatively, the receiving bank (that is, the recipient account holder's bank) may inform the account holder, using the telephone number, when funds have arrived and/or cleared. In this way, the account holder is provided with additional useful information about payments that are made to him. Of course, transaction processing systems at either or each end of the transaction would need to be adapted according to the principles laid out herein to take maximum advantage of such an arrangement.

There are many other ways of determining a synthetic bank account number. For example:
A. Using a memorable word or phrase, such as “CITIZENSBANK”. In this case, the word or phrase can readily be converted (if necessary) into a numeric string using well-known telephone keypad letter assignments (in which “a”, “b” or “c” equate to “2”, “d”, “e” and “f” equate to “3” etc.). Thus, the phrase “CITIZENSBANK” converts to the numeric string ‘248493672265’. Conversion, if required, can take place at the payer's (originating) bank. However, there is no reason in principle why it couldn't take place in another part of the end-to-end system; for example as part of the clearing network or even at the destination bank.
B. Using a communications identifier other than a telephone number that is unique to an account holder. A communications identifier might, for example, be an e-mail address, a social networking identity (such as used by MySpace or Face Book), a web site address, an IP address, a URL or the like, which can uniquely identify an account holder. Such an identifier could be used as such, in its raw form, or could be converted into another standard format. For example, an e-mail address may be converted into a numeric string, for example using the telephone keypad conversion described in A. above. In this case, for example, “.”, “@”, “-” or“_” symbols, which are commonly used in e-mail addresses, could be designated as “1” or “0”.
C. Using a hashing algorithm on any form or length of selected designation (for example, a name or e-mail address), whereby the output can be both unique (for any given input) and standards compliant. In this case, a record of hashed identities may need to be maintained in a central location (or replicated/mirrored in plural locations), in order to monitor for and prevent hash collisions (which occur when different inputs generate the same output). Such procedures are well known in relation to hash functions.

Synthetic bank account numbers can of course be assigned by any combination of the aforementioned (and any other appropriate) techniques.

According to the preceding embodiments, a second account identifier has been referred to herein as a ‘synthetic’ account identifier. This is because the account number is not the actual account number. As indicated, a synthetic account number could be provided after a normal account had been established. In other embodiments, the distinction between actual and synthetic account numbers may diminish or disappear by providing a new transaction processing system which opens accounts with one or more identifiers. Second and further account identifiers may be provided by the system when opening an account or added when required. Then, each identifier could be equally legitimate as an ‘actual’ identifier for identifying the underlying account. Further, each account identifier could be associated with particular criteria dictating the kinds of transactions that can be applied to the account if that respective identifier is used in a transaction destined for the account. There is no reason in practice why an underlying account might not be associated with two, three or many different account identifiers, each being equally valid and being associated with different criteria and/or for use in different transactions and/or for use by different third parties. Accordingly, different identifiers could be presented by the account holder to different people or categories of third party depending, for example, on an associated level of trust or the kinds of transactions (e.g. debit or credit) that are expected.

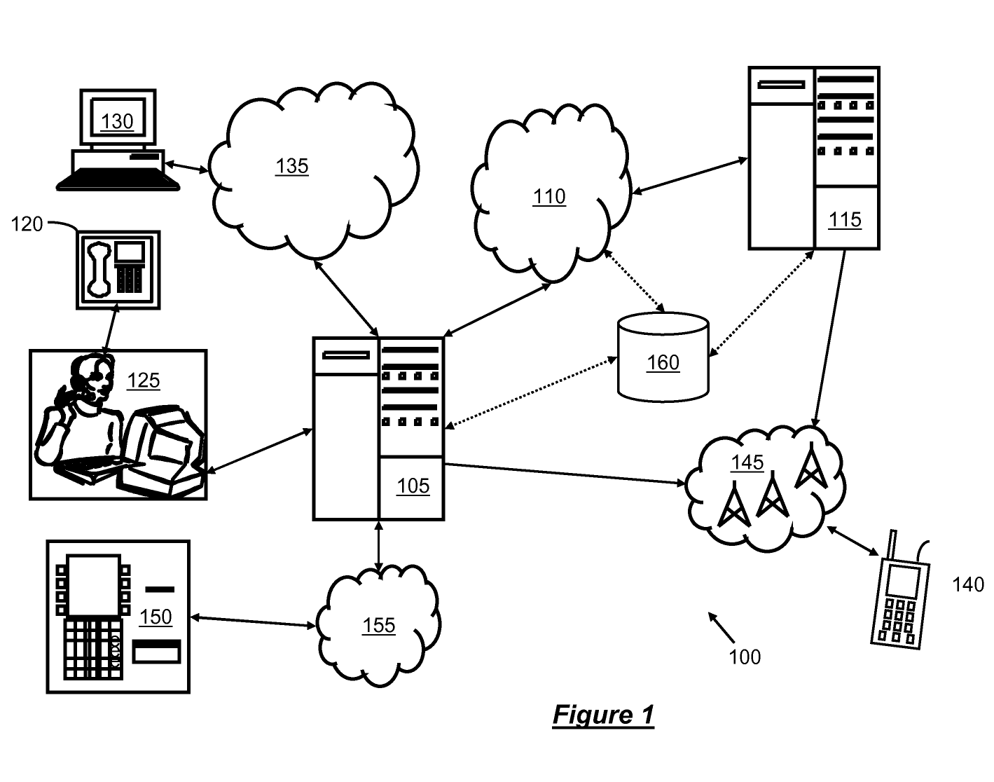

An exemplary embodiment of the present invention will now be described with reference to the system diagram in FIG. 1.

FIG. 1 illustrates an exemplary, end-to-end banking system 100. In the system, a first proprietary transaction processing system 105 (owned and operated by a first, originating bank) is connected, via an inter-bank clearing network 110 such as BACS or CHAPS in the UK, to a second proprietary transaction processing system 115 (owned and operated by a second, destination bank). The proprietary transaction processing systems 105, 115 hold and service the bank accounts of the respective banks. Both transaction processing systems are computerised and typically operate on known mainframe computing platforms employing enterprise scale application programs, such as DB2 for providing database management and CICS for automated transaction processing. The application programs will, of course, be programmed to operate according to the particular needs of the respective institution, including by being configured to operate in accord with embodiments of the present invention. Any other known and appropriate arrangement of computing platform and application program may of course be used.

Either transaction processing system may issue transaction requests to transfer funds from an account it manages to an account managed by the other bank, and visa versa. Of course, in practice, many other banks will be connected to the clearing network 110; and only two are shown for ease of understanding only. Transaction requests can be initiated in a number of known ways. As shown, in respect of the first transaction processing system 105, an account holder (not shown) may contact his bank by telephone 120 and speak to a call operator 125 or IVR/AVR system (not shown) at the bank, or set-up the transaction using a personal computer 130, which communicates on-line with the transaction processing system 105 via the Internet 135. Alternatively, the account holder may set-up the transaction using a mobile banking application operating on a portable communications device 140, such as a PDA or mobile telephone, via a mobile telephone network 145. It is also known that a transaction can be set up via an ATM 150, which is connected to the bank by an ATM network 155, or within a branch. It is also known that account transactions can be set up at a third party agency (not shown), which is not part of a bank, or even by postal order, which may be posted to, received and executed by a bank. All such modes of communication in order to set up a transaction are well known and are not descried herein in further detail.

The portable communications device 140 in FIG. 1 may also be used by the first transaction processing system 105 and the second transaction processing system 115 to communicate transaction processing details (initiation and receipt respectively) to the recipient account holder, as has already been described above.

A transaction request is typically formatted, according to a standard specified by the clearing network 110, and communicated from one bank 105 to another 115 using the clearing network 110. Of course, if the transaction is between two accounts held by the same bank, then the transaction would typically be managed within the proprietary system and would not need to travel across and/or use the clearing network and its required format(s). However, embodiments of the present invention apply equally to transactions between accounts held by the same bank.

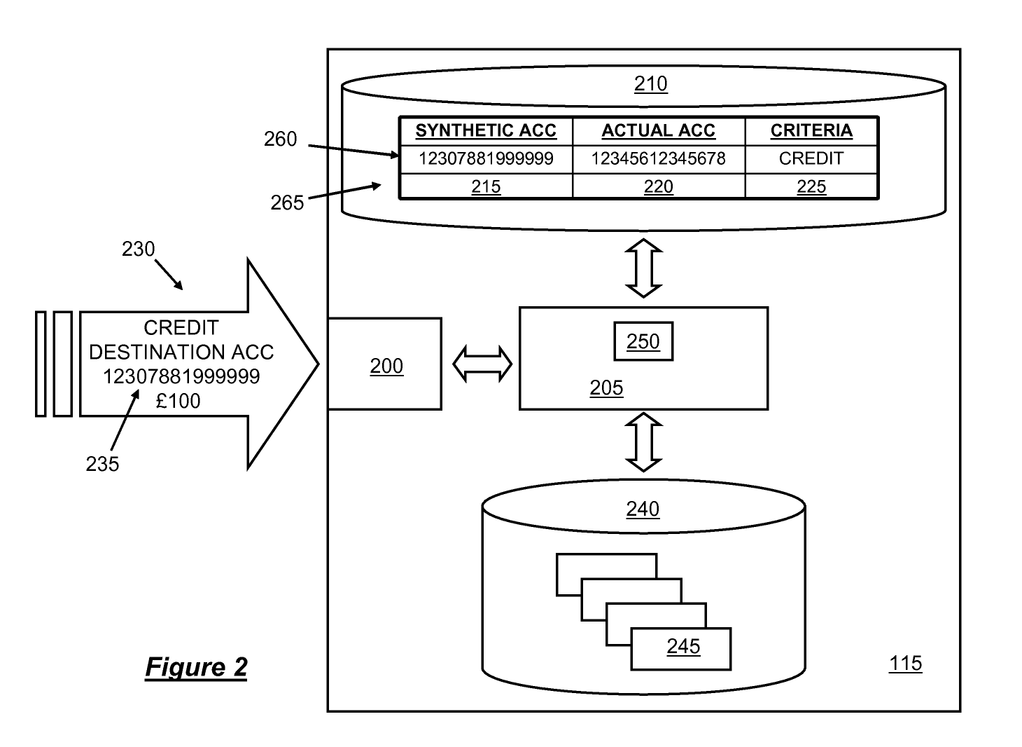

The diagram in FIG. 2 illustrates in more detail certain components of the second proprietary transaction processing system 115 that is shown in FIG. 1, which has been adapted to operate according to embodiments of the present invention. The system comprises an interface 200 for receiving transaction requests 230, a transaction processor 205 for handling the requests, a synthetic account database 210, which maps and associates synthetic accounts 215 to actual accounts 220 and specifies the criteria 225 associated with transaction requests 230 using a synthetic account identifier 235, and an account database 240, which contains the actual account records of the bank accounts 245 held by the bank, the account records each being associated with actual account numbers 220 of the synthetic account database 210.

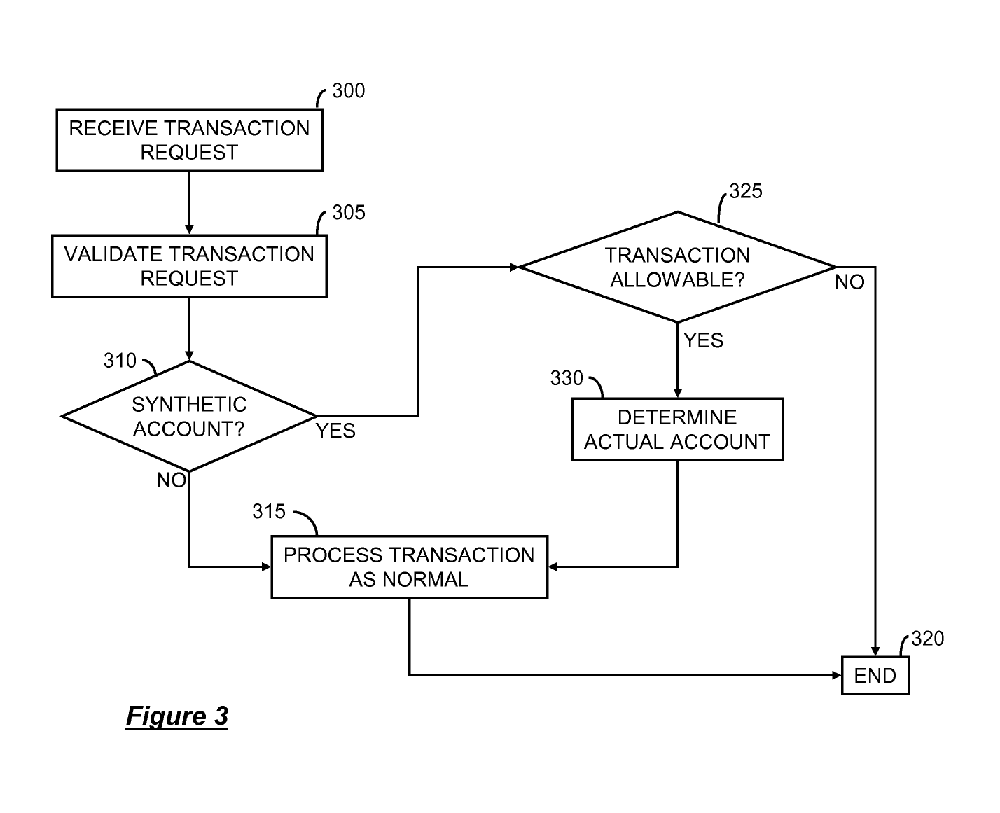

The flow diagram in FIG. 3 shows the steps involved in receiving a transaction request 230 identifying the destination account 12307881999999. In this example, the transaction request 230 is assumed to be a credit transfer for the sum of £100 from an account held by the first proprietary transaction processing system 105.

According to FIG. 3, the interface 200 receives a transaction request 230 and passes it to the transaction processor 205 [step 300]. The transaction processor 205 includes a validation function 250, which validates the request [step 305] by checking that the form of the destination sort code and account are correct. In some cases, as will be described below, the bank account identifier (including in this example a sort code and bank account number) includes a modulus check operation, that enables the validation function 250 to check that the form of the account identifier 235 complies with a required form.

Although not shown, it is taken for granted that any failed authorization step or the like would result in the failure of the transaction request, accompanied by known, attendant reporting and logging operations.

Assuming the form of the account identifier is correct, the transaction processor 205 next determines whether the destination bank account identifier 235 is a synthetic account identifier 215 by accessing the synthetic account database 210 [step 310]. The synthetic account database 210 contains records for all bank accounts that have been assigned a synthetic account identifier 215. In this example, as shown, all synthetic identifiers 215 (of which only one is illustrated) are included as first fields in respective records 260 in a database table 265. Each first field 215 has a corresponding second field 220, which contains the respective actual account number, and a third field 225, which contains criteria determining the kinds of transactions that can be carried out on the actual bank account, when a transaction identifies the destination bank account using a synthetic bank account identifier.

In the present example, the single criterion is that only a ‘CREDIT’ can be applied to the bank account, if it is identified using the synthetic bank account identifier 215. Of course, other criteria can be applied, for example:
credits and small debits, for example less than £10;
debits by certain institutions (for example, insurance companies that are well-known to the account holder and the bank)—that is, trusted third parties—which may have been pre-registered as part of the criteria;
payments to third parties that have been pre-authorised by the account holder—for example an authorised, regular direct debit;
etc.

Each database record 260 may include one or more additional criteria fields, depending on how many different account identifiers and respective sets of criteria there are.

In general, the criteria applied to transactions that can take place using the synthetic bank account identifier are different from transactions that can take place using the actual bank account identifier. Typically (though not necessarily) transactions that can take place using the synthetic account identifier would be more restrictive than transactions that can take place using a first, actual account identifier. Indeed, the criteria can be set up so that, in effect, the only person who can generate a debit from the account is the account holder; his being the only person who has knowledge of the actual account identifier.

If the database 210 does not contain an entry for the bank account identifier 235, it is assumed that the identifier is an actual account identifier and the transaction is processed [step 315] according to known procedures for crediting or debiting an account, and then the process ends [step 320]. Procedures for crediting and debiting an account will not be described in further detail as they are well known to the skilled person.

If the transaction 230 contains a synthetic bank account identifier that is in the synthetic account database 210, the transaction processor 205 compares the kind of transaction requested against the respective criteria (in the third field) to determine whether the transaction is allowable [step 325]. In this example, the transaction request is to transfer £100 into the destination bank account, 123078819999999, which is allowable according to the criteria. If the transaction request is not allowed, then the process ends [step 320]. Although not shown, a failure message may be returned to the originating bank.

Next the transaction processor 205 determines the actual account identifier from the second field 220 in the synthetic account database 210 [step 315], and the credit transaction is processed according to known procedures for crediting an account [step 315]. In practice, the transfers may be immediate or added to a batch process which happens only once a day, for example at midnight. The process then ends [step 320].

Of course, there are many ways to link a synthetic account identifier to an actual account, and different banks, having different proprietary transaction processing systems and infrastructures, may implement different solutions on the basis of the teachings herein. In addition, there are many different ways to flag or otherwise determine the criteria or rules which dictate which kinds of transactions, and under which different circumstances, can be applied to an account. Overall, however, embodiments of the present invention are advantageously designed so that transactions can occur between banks, even if only the initiating or only the receiving bank has a transaction processing system modified according to embodiments of the present invention. This is because the account identifiers remain of standard form, that would be recognised by any institution.

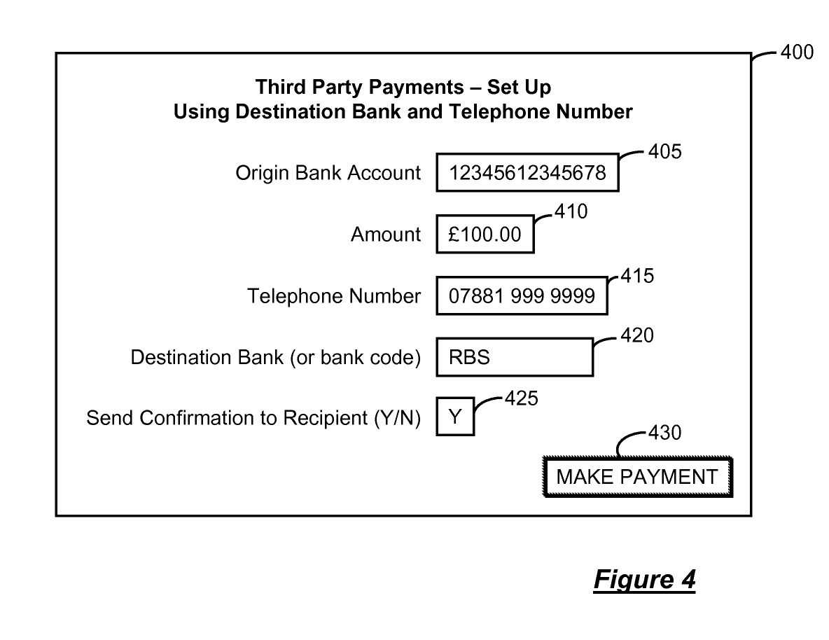

The diagram in FIG. 4 illustrates a screen-shot of an exemplary payments set-up interface 400, of the kind usable with an on-line Internet banking application, for example controllable by computer 130. Such applications are typically accessed by account holders who are able to log-in to their bank's Internet banking service. In this example, previous interface screens (not shown) would have provided the payer with an opportunity to select whether to set up a normal payment or whether to set up a payment using a bank account name (or reference) and a telephone number. The option to set up a transaction using a bank account name and telephone number in this way does not presently exist, and suitable interfaces would need to be provided to operate as described herein. Obviously the option of setting up the same transaction as a normal payment, by specifying bank sort code and account number, would be available using existing interfaces and on-line systems without any kind of alteration; and normal interface screens need not be illustrated herein.

According to the diagram in FIG. 4, the interface 400 provides the payer with a form field 405 to select their originating bank account, a field 410 to enter the amount to be paid, a field 415 to enter the telephone number and a field 420 to identify the destination bank. The information added to the fields is, according to embodiments of the invention, sufficient to generate a payment transaction from an originating bank account to a destination bank account. As already indicated, the telephone number and bank name information may be sufficient, as such, for the transaction, or the bank name may need to be converted into a particular format or number. In the latter case, as shown in FIG. 1, a database 160 holds mappings for converting bank names or codes to numbers suitable for generating an in-format account identifier. The database 160 is shown connected by dotted lines to both transaction processing systems 105, 115 and also to the clearing network 110. This indicates that the database 160 could be a central database accessible by each of these system elements, or it could be part of any one or more of the system elements, for the purposes of converting bank names or codes to account identifier numbers. A final field 425 of the interface enables the payer to specify whether the respective transaction processing system should communicate a message to the intended recipient using the telephone number when the transaction has been initiated. In other embodiments, such a communication to the recipient may be automatic rather than optional. Finally, a ‘Make Payment’ button 430 is provided to initiate the transaction.

The examples described and illustrated herein have required an account identifier to include both bank identifier and bank account identifier portions. It is of course conceivable that systems may not need to identify a destination bank as such, it being sufficient to provide a unique identifier for a destination account or recipient. In such cases, the destination account, according to embodiments of the present invention, would still be identifiable by two or more account identifiers, which may be associated with different criteria. Alternatively, or in addition, bank sort codes could be reserved for identifiers that use telephone numbers or any other kind of personalized identifier. In this way, a destination bank could know immediately that a transaction request relates to a synthetic account identifier.

The general principles described herein are clearly not limited only to UK domestic funds transfers using a BACS format of account identifier. For example, IBAN codes are used for inter-bank transfers across Europe. It is possible to adapt an IBAN code to use a synthetic account identifier.

An IBAN code consists of a header placed in front of a country's normal domestic account number format. This header consists of a two character country code ‘GB’ followed by a pair of check digits ‘19’. In the United Kingdom, and in some other European countries, the second four digits in front of the standard domestic account (comprising the remaining 14 digits for a UK code) clearly identify the issuing bank.

An example of a UK-originating IBAN code is:

GB19 RBOS 3096 1700 7099 43

The country code enables recognition of the country in which the IBAN was issued. It also indicates the national account structure to be used when deciphering the domestic account number contained within the IBAN.

The check digits are calculated by the financial institution issuing the IBAN, using a formula applied to the whole IBAN. There is a formula by which any party can perform an integrity check on an IBAN that has been quoted to them.

According to embodiments of the present invention (and using the first and second identifiers provided above), a first, actual IBAN code might appear as:

GB19 RBOS 9876 5412 3456 78

and a respective, second synthetic IBAN code might appear as:

GB19 RBOS 9870 2076 6699 99.

As far as the initiating bank or clearing network is concerned, the first and second IBAN codes are format-compliant and equally valid. Only the destination bank transaction processing system and respective destination account holder know the significance of using one or other of the codes.

As indicated above, in the UK, some account identifiers embody a modulus check capability, whereby a combination of a 6 digit sort code and an 8 digit bank account number can be generated in a way that enables them to be verified for correct pairing. The verification determines whether or not the sort code and account number can go together. This is useful to detect mis-typed entries, for example. Modulus checking as used by some UK banks is known and will not be described herein; for further detail, see Vocalink at:

http://www.vocalink.com/VocaLink/En/Home/

In instances where a bank applies modulus checking to its account identifiers, it is not always possible to generate a synthetic account identifier simply by substituting in a telephone number or the like, since it is unlikely that an existing sort code and telephone number combination would pass a modulus check. Therefore, it may be necessary to adapt the process that has been described, for example, as follows:
use the first two digits of the sort code to identify the bank as normal for a synthetic account identifier;
exclude the leading zero from the telephone number and use the remaining 10 digits as digits 5 to 14 of the synthetic account identifier (if mobile telephone numbers are used in the UK, then both “0” and “7” could be omitted as all mobile telephone numbers are known to begin with “07”); and
calculate digits 3 and 4 of the synthetic account identifier so that the modulus checking is satisfied.

Of course, this procedure relies on the bank designated by the first two digits of the synthetic account identifier having available sort codes in the range including the second two (calculated) digits and the second and third numbers of the telephone number.

The above embodiments are to be understood as illustrative examples of the invention. Further embodiments of the invention are envisaged and will become evident on the basis of the foregoing description. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An automated transaction processing system, including at least one bank account record and associations between the record and at least a first account identifier and a second account identifier for the respective account, the system comprising a transaction processor, to process received transaction requests identifying the account on the basis of first criteria, if the transaction request identifies the account using the first identifier, or second, different criteria, if the transaction request identifies the account using the second identifier.

2. A system according to claim 1, wherein the criteria govern the kinds of transaction that can be enacted on the transaction account.

3. A system according to claim 1, wherein the first criteria is/are less restrictive than the second criteria.

4. A system according to claim 1, wherein the first criteria permit both credit and debit transactions whereas the second criteria permit only credit transactions.

5. A system according to claim 1, including associations between first and second identifiers and the respective account.

6. A system according to claim 1, wherein the first and second identifiers each comply with the same standard format.

7. A system according to claim 1, wherein the first identifier complies with a first format and the second identifier complies with a second format.

8. A system according to claim 7, further comprising a means to convert or modify a second identifier to comply with the first format.

9. A system according to claim 1, wherein the second account identifier includes a personal identifier.

10. A system according to claim 9, wherein the personal identifier comprises a communications identifier.

11. A system according to claim 10, wherein the communications identifier is a telephone number or part thereof.

12. A system according to claim 10, adapted to communicate with a party using the communications identifier.

13. A method of enacting a financial transaction including by:
issuing at least two account identifiers for an account; and
processing transaction requests identifying the account on the basis of first criteria, if the transaction request identifies the account using the first identifier, or second, different criteria, if the transaction request identifies the account using the second identifier.

14. (canceled)
